(19) United States
(12) Patent Application Publication
(10) Pub. No.: US 2021/0001252 A1
(43) Pub. Date: Jan. 7, 2021

(54) DETECTION DEVICE

(71) Applicant: ISUZU MOTORS LIMITED, Tokyo (JP)

(72) Inventors: Yoshihisa FUKUDA, Fujisawa-shi, Kanagawa (JP); Yoshitaka TATARA, Fujisawa-shi, Kanagawa (JP); Shouzou OONO, Fujisawa-shi, Kanagawa (JP)

(21) Appl. No.: 16/982,515

(22) PCT Filed: Mar. 15, 2019
(86) PCT No.: PCT/JP2019/010782

§ 371 Date: Sep. 18, 2020

(30) Foreign Application Priority Data
Mar. 19, 2018 (JP) 2018-051110

(51) Int. Cl. B01D 35/143; F16H 57/04

(52) U.S. Cl. CPC B01D 35/1435; F16H 57/0436; F16H 57/0405; F16H 57/0404

(57) ABSTRACT

A detection device includes a strainer that is provided within a flow channel through which lubricating oil flow, that includes a filter member which lets through at least some of the lubricating oil and filters out foreign matter in the lubricating oil, and that is moved in the lubricating oil flowing direction along with the accumulation of foreign matter in the filter member, a stroke sensor that senses movement of the strainer in the flowing direction, and a detection unit that detects the mixing of foreign matter in the lubricating oil on the basis of the strainer movement sensed by the stroke sensor.

### TECHNICAL FIELD

The present disclosure relates to a detection device that detects mixing of foreign matter in a fluid such as lubricating oil.

### BACKGROUND ART

In general, a vehicle includes power transmission devices such as a final drive device, a transfer device, and a transmission. In these power transmission devices, lubricating oil that lubricates gears and bearings is enclosed and circulated in a housing.

In the power transmission devices, the gears or the like are worn, and thus, foreign matter, such as metal powders and broken pieces, generated due to the wear, is mixed in the lubricating oil. When such foreign matter is mixed in the lubricating oil, the gears, the bearings, oil seals, or the like may be damaged, and lifetimes thereof may be shortened.

For example, Patent Literature 1 discloses a technology for removing foreign matter in lubricating oil by adsorbing metal powders or the like mixed in lubricating oil of a final drive device by a magnet placed in a housing.

### CITATION LIST

### Patent Document

Patent Literature 1: JP-A-H08-312754

### SUMMARY OF THE INVENTION

### Technical Problem

However, in only the adsorption of the metal powders by the magnet as in the above technology described in Patent Literature 1, foreign matter such as a non-magnetic material cannot be removed particularly, and mixing of foreign matter in lubricating oil cannot be sufficiently prevented. When the amount of foreign matter mixed in lubricating oil is too large, and gears or the like are damaged, the final drive device is in a state of being disable to transmit power. Thus, on-road failures of a vehicle may be caused. Therefore, the on-road failures of the vehicle are desired to be prevented in advance by effectively detecting the mixing of foreign matter in the lubricating oil and appropriately notifying a driver of a sign of failures.

An object of the present disclosure is to provide a detection device that enables to detect mixing of foreign matter in a fluid effectively.

### Solution to Problem

A detection device according to an aspect of the present disclosure includes:

a collection unit that includes a collection member which is provided in a flow path in which a fluid flows and which collects foreign matter in the fluid by passing the fluid through at least a part thereof, and that is moved in a flowing direction of the fluid with the an accumulation of the foreign matter at the collection member;

a sensing unit that senses a movement of the collection unit in the flowing direction; and

a detection unit that detects mixing of foreign matter in the fluid based on the movement of the collection unit sensed by the sensing unit.

The detection device preferably further includes an alarm unit that gives an alarm based on the mixing of foreign matter detected by the detection unit.

It is preferable that the sensing unit is a stroke sensor which acquires a movement amount of the collection unit, and the detection unit estimates an amount of foreign matter mixed in the fluid based on the movement amount acquired by the stroke sensor, and allows the alarm unit to give an alarm when the amount of foreign matter mixed reaches a predetermined upper limit threshold.

It is preferable that the sensing unit is a stroke sensor which acquires a movement amount of the collection unit, and the detection unit allows the alarm unit to give an alarm when the movement amount acquired by the stroke sensor reaches a predetermined upper limit threshold.

It is preferable that the sensing unit is an ON/OFF sensor which is switched from OFF to ON, or from ON to OFF in accordance with a movement of the collection unit, and the detection unit allows the alarm unit to give an alarm when the ON/OFF sensor is switched from OFF to ON, or from ON to OFF.

It is preferable that the detection device further includes a biasing unit that presses the collection unit in a direction opposite to the flowing direction, and the collection unit is moved in the flowing direction against a biasing force of the biasing unit with an accumulation of the foreign matter at the collection member.

The collection unit may be a strainer member which is formed in a cylindrical shape with a bottom by a mesh member enabling to collect foreign matter in the fluid, and in which a cylinder opening side thereof is directed to an upstream side in the flowing direction.

The fluid may be lubricating oil which circulates in a housing of a power transmission device for a vehicle, and the flow path may be a lubricating oil passage which is formed in the housing and allows the lubricating oil to flow.

### Advantageous Effects of Invention

According to the present disclosure, the mixing of foreign matter in the fluid can be detected effectively.

### BRIEF DESCRIPTION OF THE DRAWINGS

FIG. 1 is a schematic vertical cross-sectional view of a power transmission device including a detection device according to a first embodiment.

FIG. 2A is a schematic partial sectional view illustrating the detection device according to the first embodiment.

FIG. 2B is a schematic partial sectional view illustrating the detection device according to the first embodiment.

FIG. 3 is a schematic functional block diagram of an electronic control unit according to the first embodiment.

FIG. 4 is a flowchart showing foreign matter detection processing according to the first embodiment.

FIG. 5 is a schematic functional block diagram of an electronic control unit according to a second embodiment.

FIG. 6 is a flowchart showing foreign matter detection processing according to the second embodiment.

FIG. 7 is a schematic functional block diagram of an electronic control unit according to another embodiment.

### DESCRIPTION OF EMBODIMENTS

A detection device according to an embodiment will be described below with reference to the accompanying drawings. The same components are denoted by the same reference numerals, and names and functions of these components are also the same. Therefore, detailed descriptions of the same components are not repeated.

### First Embodiment

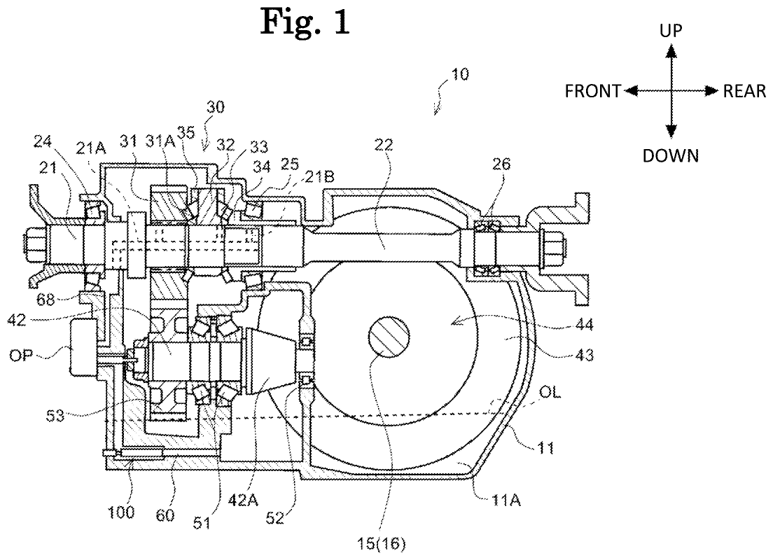

FIG. 1 is a schematic vertical cross-sectional view of a power transmission device 10 including a detection device 100 according to a first embodiment. As illustrated in FIG. 1, the power transmission device 10 is a final drive device mounted on a rear biaxial drive vehicle including two drive shafts (rear front-axle and rear rear-axle) as a rear axle. The vehicle may be any of a rear-wheel drive vehicle, a front-wheel drive vehicle, a four-wheel drive vehicle, and the like. The power transmission device 10 is not limited to a final drive device and may be other power transmission devices such as a transfer device and a transmission.

The final drive device 10 includes a housing 11. In a bottom portion 11A of the housing 11, lubricating oil as an example of a fluid (a schematic liquid level OL in the drawing is indicated by a broken line) is stored. The final drive device 10 includes an input shaft 21, an output shaft 22, a drive pinion 42, and a gear mechanism 30.

The input shaft 21 is rotatably supported by the housing 11 via a bearing 24. An output end of a propeller shaft to which a driving force is transmitted from a transmission or the like (not illustrated) is connected to the input shaft 21.

The output shaft 22 is disposed coaxially with the input shaft 21, and is rotatably supported by the housing 11 via bearings 25 and 26. An input end of a propeller shaft that transmits a driving force to a rear rear-axle (not illustrated) is connected to the output shaft 22.

The drive pinion 42 is disposed in the housing 11 in parallel to the input shaft 21, and is rotatably supported by the housing 11 via bearings 51 and 52. A drive pinion gear 42A is provided on one end of the drive pinion 42, and a ring gear 43 meshes with the drive pinion gear 42A. The ring gear 43 is fixed to a differential cage (not illustrated) constituting a part of a rear-front differential mechanism 44. The rear-front differential mechanism 44 includes a differential cage, a side gear, a differential pinion gear, a spider, or the like (all are not illustrated), and transmits a driving force to left and right drive shafts 15 and 16 (the right drive shaft 16 is not illustrated) while allowing the differential.

The gear mechanism 30 transmits the driving force transmitted to the input shaft 21 to the output shaft 22 and the drive pinion 42 while allowing the differential. Specifically, the gear mechanism 30 includes a gear 31, a spider 32, a pair of pinion gears 33, a side gear 34, and a cage 35. The gear 31 is rotatable relative to the input shaft 21 and is meshed with a gear 53 fixed to the drive pinion 42. A side gear 31A of the gear 31 meshes with the pair of pinion gears 33. The side gear 34 is integrally rotatably fixed to the output shaft 22 and meshes with the pair of pinion gears 33. The pair of pinion gears 33 are rotatably inserted into the spider 32, respectively. The spider 32 is fixed to the cage 35 that is integrally rotatable with the input shaft 21.

An oil pump OP, which pumps up and pressure-feeds the lubricating oil stored in the bottom portion 11 A of the housing 11, is provided on a side portion of the housing 11. The oil pump OP is, for example, a gear pump or a trochoid pump, and is driven by power transmitted from the drive pinion 42.

A downstream oil-passage 60, which allows the bottom portion 11A for storing the lubricating oil to communicate with a suction port of the oil pump OP, is provided inside the housing 11. An upstream oil-passage 68, which allows a discharge port of the oil pump OP to communicate with an axial oil passage 21A formed in the input shaft 21, is provided inside the housing 11. When the oil pump OP is driven, the lubricating oil in the bottom portion 11 A is pumped up through the downstream oil-passage 60 and is pressure-fed to the upstream oil-passage 68. The lubricating oil that is pressure-fed to the upstream oil-passage 68 is supplied to lubrication elements such as bearings via the axial oil passage 21A and a plurality of radial oil passages 21B in the input shaft 21 and returns to the bottom portion 11A to circulate.

In the present embodiment, the detection device 100 is provided in the downstream oil-passage 60. Details of the detection device 100 will be described below.

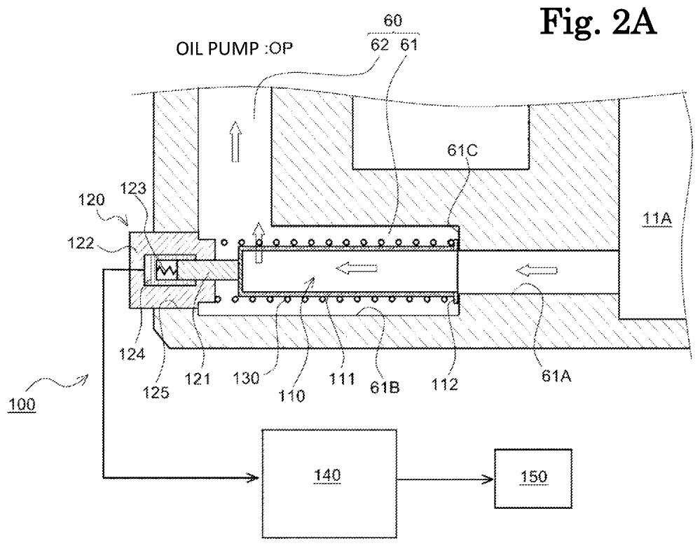

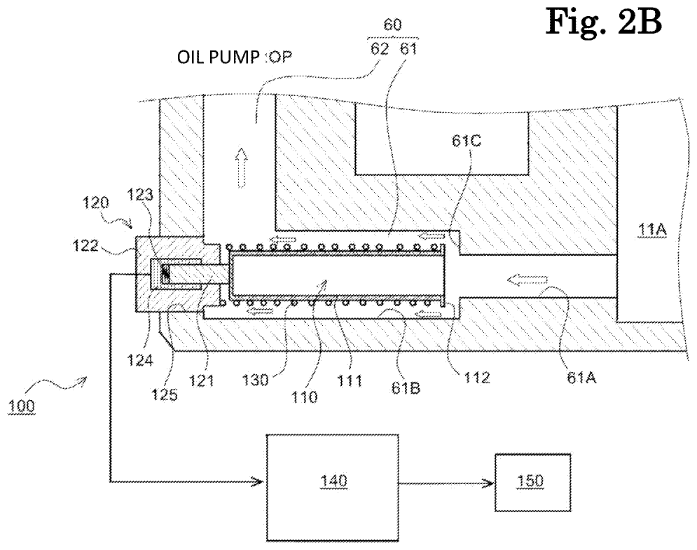

FIGS. 2A and 2B are schematic partial sectional views illustrating the detection device 100 according to the present embodiment. As illustrated in FIGS. 2A and 2B, the detection device 100 includes a strainer 110 (collection unit), a stroke sensor 120 (sensing unit), a spring 130 (biasing unit), an electronic control unit 140 (detection unit), and an alarm 150 (alarm unit). Among these components, the strainer 110, a part of the stroke sensor 120, and the spring 130 are disposed in the downstream oil-passage 60.

The downstream oil-passage 60 is bent in a substantially L-shape, and includes a lateral flow path 61 extending laterally from the bottom portion 11A of the housing 11, and a vertical flow path 62 extending vertically from a downstream end of the lateral flow path 61 to an oil pump OP side. The lateral flow path 61 includes a small-diameter flow path portion 61A on an upstream side, and a large-diameter flow path portion 61B on a downstream side, and an annular stepped surface 61C is formed between the small-diameter flow path portion 61A and the large-diameter flow path portion 61B.

The strainer 110 includes a strainer body portion 111 (collection member) formed in an approximately cylindrical shape with a bottom by a mesh member that passes the lubricating oil and can collect foreign matter (for example, iron powders and broken pieces generated due to wear of gears: simply referred to as foreign matter) contained in the lubricating oil. A cylinder axial length of the strainer body portion 111 is shorter than a flow path axial length of the large-diameter flow path portion 61B. The strainer body portion 111 is accommodated in the large-diameter flow path portion 61B in a manner of being movable in a flowing direction of the lubricating oil. An annular flange portion 112, which is bent radically outward at a substantially right angle, is provided at a peripheral edge of an opening of the strainer body portion 111.

An inner diameter of the flange portion 112 and an inner diameter of the strainer body portion 111 are preferably formed to be substantially the same as a flow path diameter of the small-diameter flow path portion 61A. An outer diameter of the flange portion 112 is formed to be smaller than a flow path diameter of the large-diameter flow path portion 61B. The flange portion 112 is disposed in a press-contact state with the stepped surface 61C by a biasing force of the spring 130.

The stroke sensor 120 includes a shaft 121 that abuts against a cylinder bottom outer surface of the strainer body portion 111, a bottomed cylindrical casing 122 that supports the shaft 121 in a stroke movable manner, a return spring 123 (biasing unit) that causes the shaft 121 to return to an original position, and a detection element unit 124 that detects a stroke movement amount S of the shaft 121 corresponding to the movement amount of the strainer 110. The stroke movement amount S detected by the detection element unit 124 is input to the electronic control unit 140 that is electronically connected to the detection element unit 124.

In the present embodiment, the stroke sensor 120 is detachably attached to the housing 11 by screwing a male screw portion (not illustrated) formed on an outer periphery of the casing 122 with a female screw portion (not illustrated) formed on an inner periphery of a through hole 125 of the housing 11. It is configured such that the strainer 110 can be periodically replaced (including reuse) by removing the stroke sensor 120 from the housing 11.

One end side of the spring 130 is disposed on the flange portion 112, and the other end side thereof is disposed on a cylindrical end surface of the casing 122, and the spring 130 is held in a compressed state between the flange portion 112 and the casing 122.

When the amount of foreign matter mixed in the lubricating oil is small (or substantially zero), the amount of foreign matter collected on an inner cylindrical surface of the strainer body portion 111 (degree of clogging) is also small, and flow resistance for the lubricating oil passing through the strainer body portion 111 is small. In this case, as illustrated in FIG. 2A, the strainer 110 is held in a state in which the flange portion 112 is disposed on the stepped surface 61C by a biasing force of the spring 130, and the shaft 121 of the stroke sensor 120 is also held at a substantially original position. That is, the stroke movement amount S of the shaft 121 detected by the stroke sensor 120 is substantially zero.

When the amount of foreign matter mixed in the lubricating oil is increased and the foreign matter starts to accumulate on the inner cylindrical surface of the strainer body portion 111, the degree of clogging of the strainer body portion 111 is increased with this.

As a result, flow resistance for the lubricating oil passing through the strainer body portion 111 is gradually increased. Then, as illustrated in FIG. 2B, the strainer 110 stroke-moves in a flow direction of the lubricating oil against the biasing force of the spring 130. When the strainer 110 stroke-moves, the lubricating oil flowing through the small-diameter flow path portion 61A flows through a gap between the flange portion 112 and the stepped surface 61C and flows in the large-diameter flow path portion 61B.

At this time, the stroke movement amount S of the shaft 121 detected by the stroke sensor 120 gradually increases in accordance with the movement of the strainer 110. In particular, just before the occurrence of a failure such as damages of gears or the like, the amount of foreign matter mixed in the lubricating oil is increased rapidly, flow resistance for the lubricating oil passing through the strainer body portion 111 is also increased rapidly with this. As a result, the stroke movement amount of the shaft 121 and the strainer 110 significantly increase. In the present embodiment, a change in the stroke movement amount S of the strainer 110 according to the foreign matter accumulation is used to detect the mixing of the foreign matter in the lubricating oil. The foreign matter detection processing by the electronic control unit 140 will be described in detail below.

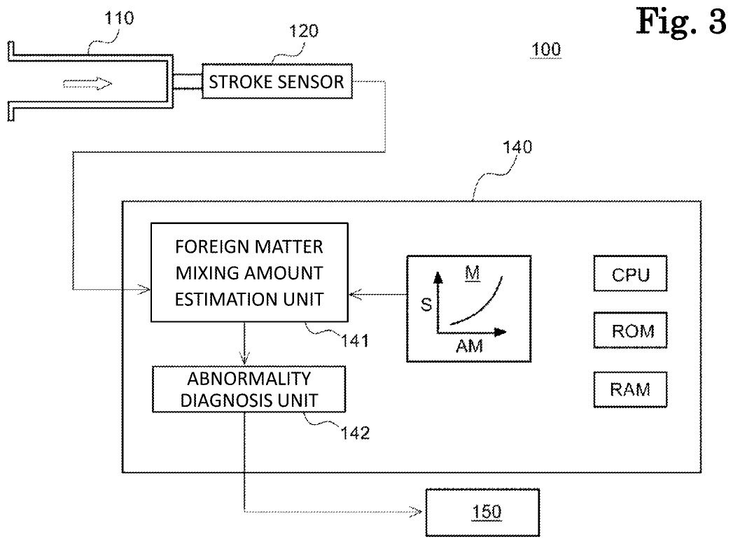

FIG. 3 is a schematic functional block diagram of the electronic control unit 140 according to the present embodiment. The electronic control unit 140 performs various types of control of a vehicle and includes a CPU, a ROM, a RAM, an input port, an output port, and the like, which are known. The electronic control unit 140 includes a foreign matter mixing amount estimation unit 141 and an abnormality diagnosis unit 142 as part of functional elements. Each of these functional elements is described as being contained in the electronic control unit 140 which is integrated hardware, and any one of the functional elements may be provided in separate hardware.

The foreign matter mixing amount estimation unit 141 estimates the amount of foreign matter mixed (foreign matter mixing amount) AM in the lubricating oil based on the stroke movement amount S of the strainer 110. Specifically, a memory of the electronic control unit 140 stores a map M defining a relationship between the stroke movement amount S of the strainer 110 and the foreign matter mixing amount AM in the lubricating oil, which is created in advance by experiments or the like. In the map M, the foreign matter mixing amount AM is set to rapidly increase as the stroke movement amount S increases. The foreign matter mixing amount estimation unit 141 estimates the foreign matter mixing amount AM by referring to the map M based on the stroke movement amount S input from the stroke sensor 120. The method of estimating the foreign matter mixing amount AM is not limited to the map M, and the foreign matter mixing amount AM may be calculated from a model formula including the stroke movement amount S as an input value.

The abnormality diagnosis unit 142 performs abnormality diagnosis whether there is a sign of occurrence of a failure due to gear damage or the like in the final drive device 10 based on the foreign matter mixing amount AM estimated by the foreign matter mixing amount estimation unit 141. Specifically, the memory of the electronic control unit 140 stores an upper limit mixing amount threshold AM_{_Max} of foreign matter that can cause a failure in the final drive device 10, which is obtained in advance by experiments or the like. When the foreign matter mixing amount AM input from the foreign matter mixing amount estimation unit 141 reaches the upper limit mixing amount threshold AM_{_Max}, the abnormality diagnosis unit 142 diagnoses that there is a sign of occurrence of a failure in the final drive device 10, and outputs an instruction signal for giving an alarm to the alarm 150. The alarm 150 may be either one of a speaker that gives an alarm by a sound and a display device that gives an alarm by a display.

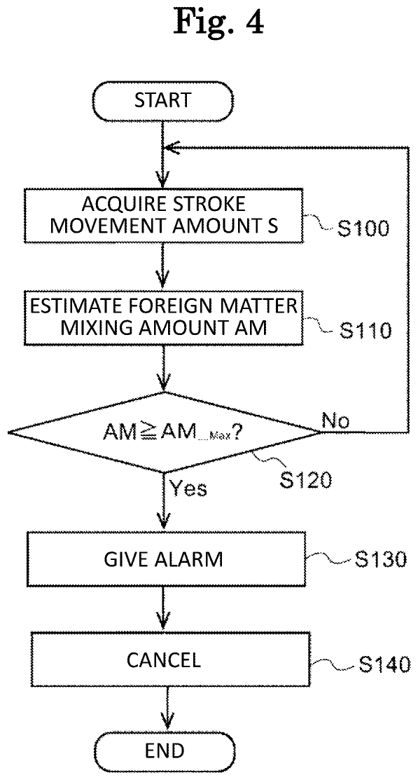

Next, a flow of the foreign matter detection processing according to the present embodiment will be described with reference to FIG. 4.

In step S100, the stroke movement amount S of the strainer 110 is acquired by the stroke sensor 120, and in step S110, the foreign matter mixing amount AM is estimated based on the acquired stroke movement amount S.

In step S120, it is determined whether the foreign matter mixing amount AM has reached the upper limit mixing amount threshold AM_{_Max}. When the foreign matter mixing amount AM reaches the upper limit mixing amount threshold AM_{_Max} (Yes), the control proceeds to the processing of step S130. On the other hand, when the foreign matter mixing amount AM is less than the upper limit mixing amount threshold AM_{_Max} (No), the control returns to the processing of step S100.

In step S130, an alarm is given by the alarm 150. Next, the alarm is canceled in step S140. As the canceling of the alarm, for example, when an alarm is given by a sound, the alarm may be canceled after a predetermined time elapses to prevent the annoyance of long-term alarm sounds. When an alarm is given by the display, the alarm may be canceled by a worker when the vehicle is maintained in a maintenance factory or the like. When the alarm is canceled in step S140, the control ends thereafter.

According to the present embodiment described in detail above, the foreign matter mixing amount AM in the lubricating oil is estimated from the stroke movement amount S of the strainer 110 that collects foreign matter in the lubricating oil, and when the estimated foreign matter mixing amount AM reaches the upper limit mixing amount threshold AM_{_Max}, it is diagnosed that there is a sign of occurrence of a failure in the final drive device 10, and an alarm is given. As a result, a driver can be appropriately notified of appropriate maintenance time in a stage before the final drive device 10 fails, and on-road failures of the vehicle can be prevented in advance.

In particular, since a degree of progress of mixing of foreign matter in the lubricating oil varies depending on a driving state of the vehicle, such as driving frequency of the vehicle and the magnitude of the input load to the gear, the failure of the final drive device 10 may not be prevented in advance only by uniformly setting the maintenance time based on a travel distance or the like. In the present embodiment, since the alarm is given based on the foreign matter mixing amount AM estimated in real time, it is possible to effectively deal with such changes in driving situations, and it is possible to reliably detect a sign of a failure in the final drive device 10.

### Second Embodiment

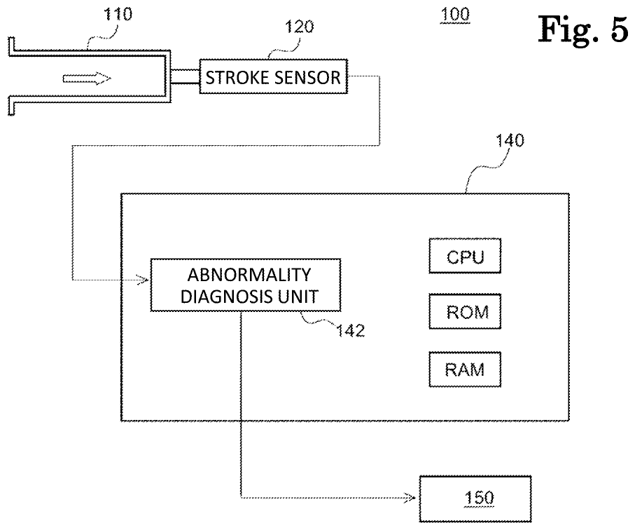

FIG. 5 is a schematic functional block diagram of an electronic control unit 140 of a detection device 100 according to a second embodiment. As shown in FIG. 5, in the detection device 100 according to the second embodiment, the foreign matter mixing amount estimation unit 141 is removed from the electronic control unit 140 according to the first embodiment. As in the first embodiment, the detection device 100 according to the second embodiment is provided in the power transmission device 10.

Specifically, the electronic control unit 140 according to the second embodiment stores, as an upper limit stroke amount threshold S_{_Max}, the stroke amount of the strainer 110 corresponding to the amount of foreign matter mixed in the lubricating oil that can cause a failure in the final drive device 10, which is acquired in advance by experiments or the like. When the stroke movement amount S input from the stroke sensor 120 reaches the upper limit stroke amount threshold S_{_Max}, the abnormality diagnosis unit 142 diagnoses that there is a sign of occurrence of a failure in the final drive device 10, and outputs an instruction signal for giving an alarm to the alarm 150.

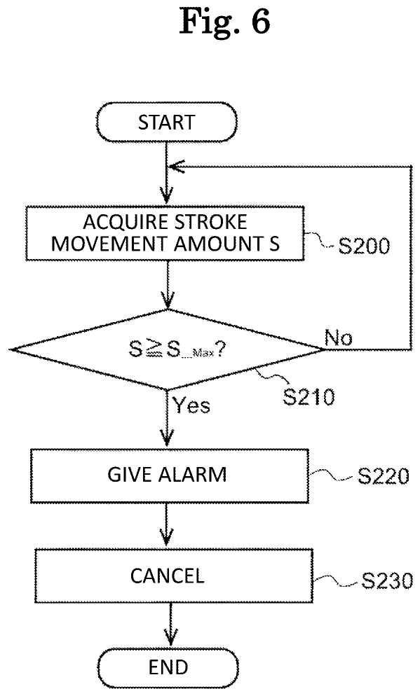

That is, in foreign matter detection processing according to the second embodiment as shown in the flowchart of FIG. 6, the stroke movement amount S of the strainer 110 is acquired by the stroke sensor 120 in step S200, and it is determined whether the stroke movement amount S has reached the upper limit stroke amount threshold S_{_Max} in step S210. If the result is Yes, the processing proceeds to step S220 to give an alarm, the alarm is canceled in step S230, and the control ends, which is similar to the first embodiment.

As described above, according to the detection device 100 in the second embodiment, by comparing the stroke movement amount S of the strainer 110 with the upper limit stroke amount threshold S_{_Max}, it is possible to effectively detect a sign of a failure in the final drive device 10, and the same operation and effect as those of the first embodiment can be obtained.

The present disclosure is not limited to the above-described embodiments and can be appropriately modified and implemented without departing from the spirit of the present disclosure.

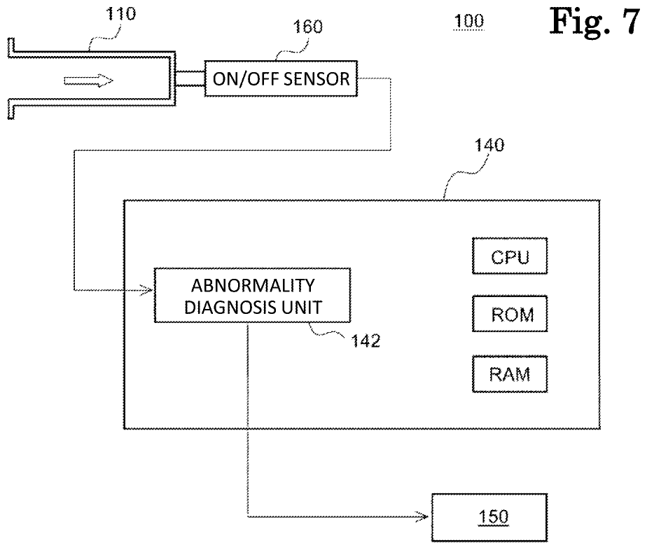

For example, the stroke sensor 120 is used in the above embodiments, and as shown in FIG. 7 an ON/OFF sensor 160 that is switched from OFF to ON (or ON to OFF) in accordance with the stroke movement of the strainer 110 may be used. When the ON/OFF sensor 160 is used, an alarm may be given when the ON/OFF sensor 160 is switched from OFF to ON (or ON to OFF) in accordance with the stroke movement of the strainer 110.

The spring 130 is not essential, and the spring 130 may be removed if the return spring 123 in the sensor has a constant reaction force.

The strainer 110 is provided in the downstream oil-passage 60 in the above description, and the strainer 110 may be disposed in another oil passage of the final drive device 10, such as the upstream oil-passage 68.

An application range of the present embodiment is not limited to a power transmission device such as the final drive device 10, a transfer device, and a transmission, and may also be widely applied to devices in which lubricating oil is circulated, such as an engine, or other devices in which a fluid other than lubricating oil circulates, as long as the device includes a gear case filled with lubricating oil.

The present application is based on a Japanese Patent Application (P2018-051110) filed on Mar. 19, 2018, contents of which are incorporated herein as reference.

### INDUSTRIAL APPLICABILITY

The detection device of the present disclosure is useful in that mixing of foreign matter in a fluid is effectively detected.

### LIST OF REFERENCE NUMERALS

10 Final drive device (Power transmission device)
11 Housing
60 Downstream oil-passage
68 Upstream oil-passage
100 Detection device
110 Strainer (Collection unit)
111 Strainer body portion (Collection member)
112 Flange portion
120 Stroke sensor (Sensing unit)
130 Spring (Biasing unit)
140 Electronic control unit (Detection unit)
150 Alarm (Alarm unit)

1. A detection device comprising:
a collection twit that includes a collection member which is provided in a flow path in which a fluid flows and which collects foreign matter in the fluid by passing the fluid through at least a part thereof, and that is moved in a flowing direction of the fluid with an accumulation of the foreign matter at the collection member;
a sensing, unit that senses a movement of the collection unit in the flowing direction; and
a detection unit that detects mixing of foreign matter in the fluid based on the movement of the collection unit sensed by the sensing unit.

2. The detection device according to claim 1, further comprising:
an alarm unit that gives an alarm based on the mixing of foreign matter detected by the detection unit.

3. The detection device according to claim 2,
wherein the sensing unit is a stroke sensor which acquires a movement amount of the collection unit, and
the detection unit estimates an amount of foreign matter mixed in the fluid based on the movement amount acquired by the stroke sensor, and allows the alarm unit to give an alarm when the amount of foreign matter mixed reaches a predetermined upper limit threshold.

4. The detection device according to claim 2,
wherein the sensing unit is a stroke sensor which acquires a movement amount of the collection unit, and
the detection unit allows the alarm unit to give an alarm when the movement amount acquired by the stroke sensor reaches a predetermined upper limit threshold.

5. The detection device according to claim 2,
wherein the sensing unit is an ON/OFF sensor which is switched from OFF to ON, or from ON to OFF in accordance with a movement of the collection unit, and
the detection unit allows the alarm unit to give an alarm when the ON/OFF sensor is switched from OFF to ON, or from ON to OFF.

6. The detection device according to claim 1, further comprising:
a biasing unit that presses the collection unit in a direction opposite to the flowing direction,
wherein the collection unit is moved in the flowing direction against a biasing force of the biasing unit with an accumulation of the foreign matter at the collection member.

7. The detection device according to claim 1,
wherein the collection unit is a strainer member which is formed in a cylindrical shape with a bottom by a mesh member enabling to collect foreign matter in the fluid, and in which a cylinder opening side thereof is directed to an upstream side in the flowing direction.

8. The detection device according to claim 1,
wherein the fluid is lubricating oil which circulates in a housing of a power transmission device for a vehicle, and
the flow path is a lubricating oil passage which is formed in the housing and allows the lubricating oil to flow.
